(19) United States
(12) Patent Application Publication
(10) Pub. No.: US 2018/0041711 A1
(43) Pub. Date: Feb. 8, 2018

(54) Selective Partial View Enlargement for Image and Preview

(71) Applicant: Motorola Mobility LLC, Chicago, IL (US)

(72) Inventors: Hai Long, Beijing (CN); Lei Peng, Beijing (CN)

(73) Assignee: Motorola Mobility LLC, Chicago, IL (US)

(21) Appl. No.: 15/228,307

(22) Filed: Aug. 4, 2016

(51) Int. Cl. H04N 5/232; H04N 5/44; H04N 5/262; H04N 5/76

(52) U.S. Cl. CPC H04N 5/23293; H04N 5/76; H04N 5/44; H04N 5/2628

(57) ABSTRACT

A system and method for use in conjunction with a device having image capture hardware allow a user to selectively enlarge a specific area in a view prior to or during image capture, or to selectively enlarge a portion of a captured image. The function enlarges a selected area of a view while leaving the remainder of the view unchanged. Similarly, the user is able to then digitally capture the previewed image, including the enlargement. In an embodiment, launching the device camera in a preview mode enables an enlargeable area, if the user chooses to use it. The user can then move the phone or the area and point it to the object or region that he or she wants to enlarge. The amplifying factor may be adjustable and the enlarged area may be highlighted or framed in the preview or in the captured image data.

### TECHNICAL FIELD

The present disclosure is related generally to mobile device functionality, and, more particularly, to a system and method for enabling a selective partial view enlargement on a display screen of a portable electronic communication device.

### BACKGROUND

Personal portable communication devices, e.g., cellular phones and “smart” phones, have become a prime platform for the release of new applications and functionality (the term “cellular phone” will be used herein to encompass traditional cell phones as well as high function “smart” phones). This is likely due to the increasing integration of such devices into all areas of user's lives. For example, most cellular phones now enable users to track schedules, conduct business, connect socially, and even entertain themselves. However, one of the oldest functions of cellular phones is also still one of the most popular: the ability to take pictures and videos.

Although the imaging capabilities of cell phones were not always of the highest quality, the convenience of having an imaging device at their fingertips was irresistible to most users. Moreover, now that cellular phone imaging capabilities are equal to or better than many dedicated cameras, users tend to treat their phone camera function as their primary or only imaging resource.

Nonetheless, there are still shortcomings in this area. For example, if a user desires to look more closely at an item in a picture, they must zoom or magnify the whole view prior to taking the picture or magnify an existing image. In either case, much of the remainder of the image becomes invisible after the magnification or zoom is executed. For example, with respect to an image that shows a cityscape, most of the buildings will be out of view if the image is zoomed to focus on a particular building. Worse yet, in the case of zooming or magnifying during image capture, the remaining portions of the view are permanently lost.

While the present disclosure is directed to a system that can eliminate certain shortcomings noted in this Background section, it should be appreciated that such a benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the art in the public domain.

As such, the inventors expressly disclaim this section as admitted or assumed prior art with respect to the discussed details. Moreover, the identification herein of a desirable course of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example device with respect to which embodiments of the presently disclosed principles may be implemented;

FIG. 2 is a simplified schematic view of a camera system or portion of a device supporting selective partial view enlargement in accordance with an embodiment of the disclosed principles;

FIG. 3 is pictorial schematic data progression showing the processing of image data in accordance with an embodiment of the disclosed principles during image preview;

FIG. 4 is a data diagram of an image capture process in accordance with an embodiment of the disclosed principles during image capture wherein a portion of the image is selected by the user for enlargement; and

FIG. 5 is a flow chart illustrating a process of image data capture and processing in accordance with an embodiment of the disclosed principles.

### DETAILED DESCRIPTION

Before presenting a full discussion of the disclosed principles, an overview of certain embodiments is given to aid the reader in understanding the later discussion. As noted above, while the camera feature is a popular function on most cellular phones, it is still not easily usable for many tasks that require detailed enlargement of portions of a view or image.

In an embodiment of the disclosed principles, a camera support module of a cellular phone (either a traditional cellular phones or a high functionality “smart” phone) is configured to selectively enlarge one or more specific areas in a view prior to or during image capture, or to selectively enlarge a portion of an already captured image. Thus, for example, in a camera preview, the user is able to select and enlarge a certain area of a view while leaving the remainder of the view unchanged (other than the portion obscured by the enlargement). Similarly, the user is able to then digitally capture the previewed image, including the enlargement.

Launching the device camera in the preview mode enables an enlargeable area, if the user chooses to use it. The user can then move the phone or the area and point it to the object or region that he or she wants to enlarge. The amplifying factor 1:x is adjustable in an embodiment, and in a further embodiment, the user's finger pressure is detected and the amplifying factor is adjusted dynamically based on the force or duration of pressure.

The user may then keep the amplifying function enabled and take the picture, and the enlarged area is then seen in the captured image as well. The enlarged area may be highlighted or framed in the preview or in the captured image data. In an embodiment, a blurred border distinguishes the enlarged portion from the remainder of the picture.

In the context of a cellular phone, the desired function may be implemented as a native phone function or as a phone app (application). Although the benefit of the improvement to still photography is clear, it should be appreciated that the same principles may be applied to enlarge a portion of a video frame as well. Moreover, although the partial enlargement feature finds high utility in the context of cellular phones, it will be appreciated that partial enlargement as described herein is also usable in a dedicated camera or other device capable of capturing an image.

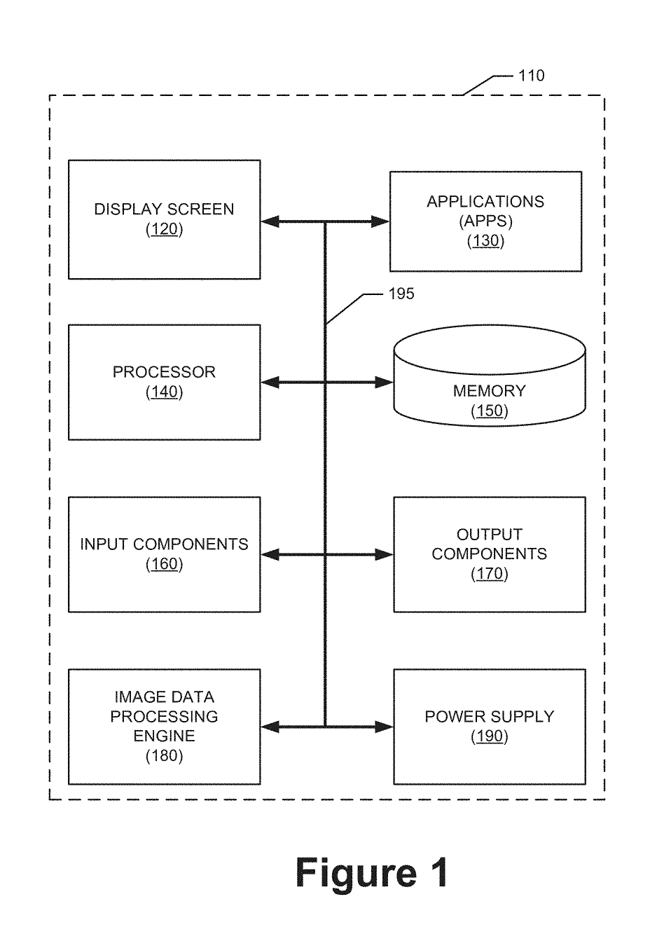

With this overview in mind, and turning now to a more detailed discussion in conjunction with the attached figures, the techniques of the present disclosure are illustrated as being implemented in a suitable computing environment. The following device description is based on embodiments and examples of the disclosed principles and should not be taken as limiting the claims with regard to alternative embodiments that are not explicitly described herein. Thus, for example, while FIG. 1 illustrates an example mobile device within which embodiments of the disclosed principles may be implemented, it will be appreciated that other device types may be used, including but not limited to personal computers, tablet computers and other devices.

The schematic diagram of FIG. 1 shows an exemplary component group 110 forming part of an environment within which aspects of the present disclosure may be implemented. In particular, the component group 110 includes exemplary components that may be employed in a device corresponding to the first device and/or the second device. It will be appreciated that additional or alternative components may be used in a given implementation depending upon user preference, component availability, price point, and other considerations.

In the illustrated embodiment, the components 110 include a display screen 120 (e.g., a touch screen), applications (e.g., programs) 130, a processor 140, a memory 150, one or more input components 160 such as speech and text input facilities, and one or more output components 170 such as text and audible output facilities, e.g., one or more speakers.

The processor 140 may be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device. Such functions may include, for example, interaction among various internal components and storage and retrieval of applications and data to and from the memory 150.

Further with respect to the applications 130, these typically utilize the operating system to provide more specific functionality, such as file system service and handling of protected and unprotected data stored in the memory 150. Although many applications may provide standard or required functionality of the user device 110, in other cases applications provide optional or specialized functionality, and may be supplied by third party vendors or the device manufacturer.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device having component group 110 may include an image data processing engine 180 which implements the image data manipulations described herein. The image data processing engine 180 may be implemented as non-transitory computer-executable instructions, e.g., stored in device memory, which are read and executed by the device processor 140. Alternatively, the image data processing engine 180 may be implemented as a separate internal module that performs the described functions, with or without support from the device processor 140.

In an embodiment, a power supply 190, such as a battery or fuel cell, may be included for providing power to the device and its components 110. All or some of the internal components 110 communicate with one another by way of one or more shared or dedicated internal communication links 195, such as an internal bus.

In an embodiment, the device 110 is programmed such that the processor 140 and memory 150 interact with the other components of the device 110 to perform certain functions. The processor 140 may include or implement various modules and execute programs for initiating different activities such as launching an application, transferring data, and toggling through various graphical user interface objects (e.g., toggling through various display icons that are linked to executable applications).

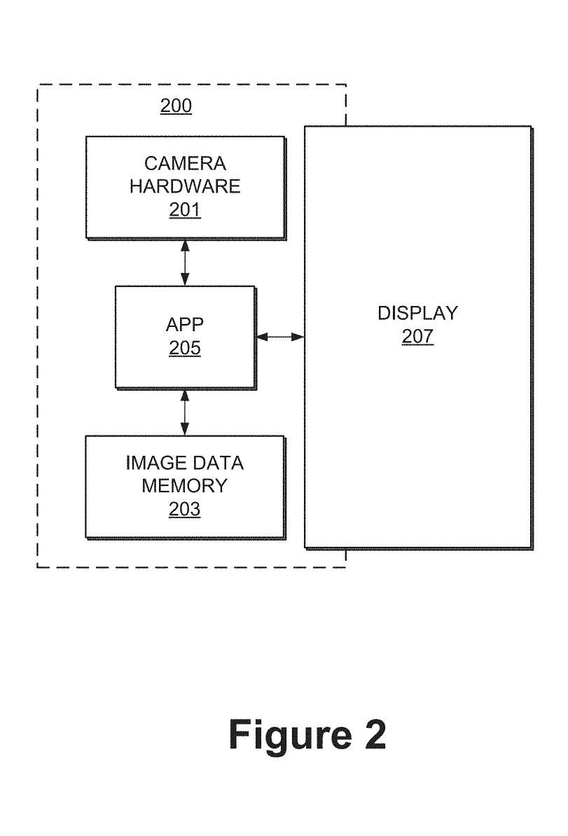

Turning to FIG. 2, this figure shows a simplified schematic view of a camera system or portion of a device supporting selective partial view enlargement in accordance with an embodiment of the disclosed principles. The primary portions of the system 200 include camera hardware 201, image data memory 203 and an image capture module or application 205 configured to execute the steps of the defined routine resulting in the desired enlargement. Also shown is a display screen 207, which may comprise the display screen 120 shown in FIG. 1.

The camera hardware 201 includes an image capture element such as a CCD (charge-coupled device) array or CMOS (complementary metal-oxide semiconductor) image sensor, an aperture and one or more lenses to focus received light corresponding to a view through the aperture and onto the image capture element. The output of the image capture element is a digital string or array representing pixels corresponding to the captured image. Alternatively, the camera hardware 201 may execute certain pre-processing such as compression or formatting prior to outputting the image data.

The image data memory 203 may be comprised of device memory such as memory 150 shown in FIG. 1 or may partially or entirely comprise dedicated memory associated with the camera system 200. In either case, the image data memory 203 supports the camera system 200 by storing preview image data and intermediate image data during processing steps.

As noted above, the image capture module or application 205 (180) implements the image data manipulations described herein, and may be implemented as non-transitory computer-executable instructions, e.g., stored in device memory, which are read and executed by the device processor 140. Alternatively, the image data processing engine 180 may be implemented as a separate internal module that performs the described functions, with or without support from the device processor 140.

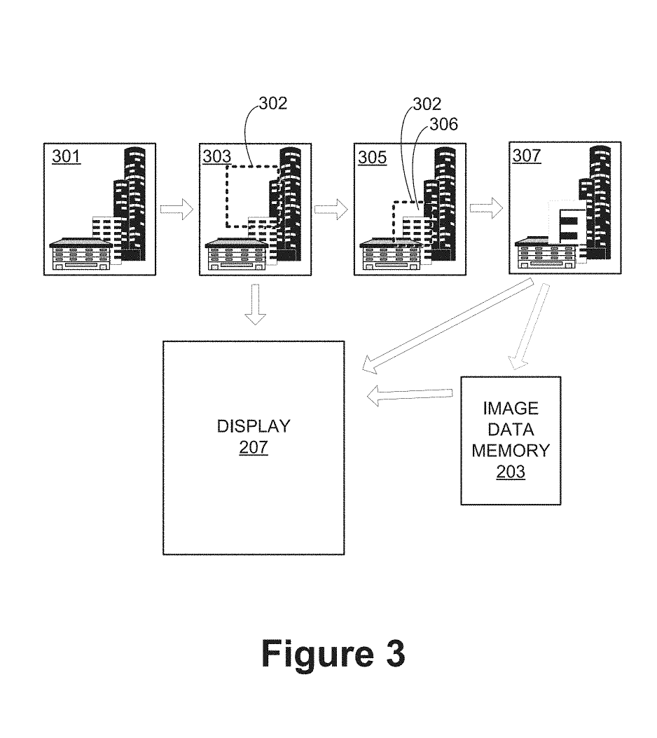

FIG. 3 is pictorial schematic data progression showing the processing of image data in accordance with an embodiment of the disclosed principles. In this view, the image data corresponding to a scene is detected at the time of image preview to produce a first image data set 301. This first image data set 301 may then have superimposed thereon a circle, dot, rectangle or other indicator 302 to form a second set of image data 303, wherein the indicator 302 is monitored for manipulation by the user. The second set of image data 303 may then be displayed to the user (e.g., via display screen 120, 207).

If the user manipulates the indicator 302 to identify a section of the view for enlargement, the second set of image data 303 is processed to relocate the indicator (intermediate image data 305) and enlarge the indicated portion 306, forming a third set of image data 307. The third set of image data 307 may then be displayed to the user. Subsequently the user may accept the preview by actuating an appropriate button, switch, touch screen element or otherwise to “take” the picture. Upon such an occurrence, the third set of image data 307 is written to nonvolatile image data memory (e.g., memory 150, 203).

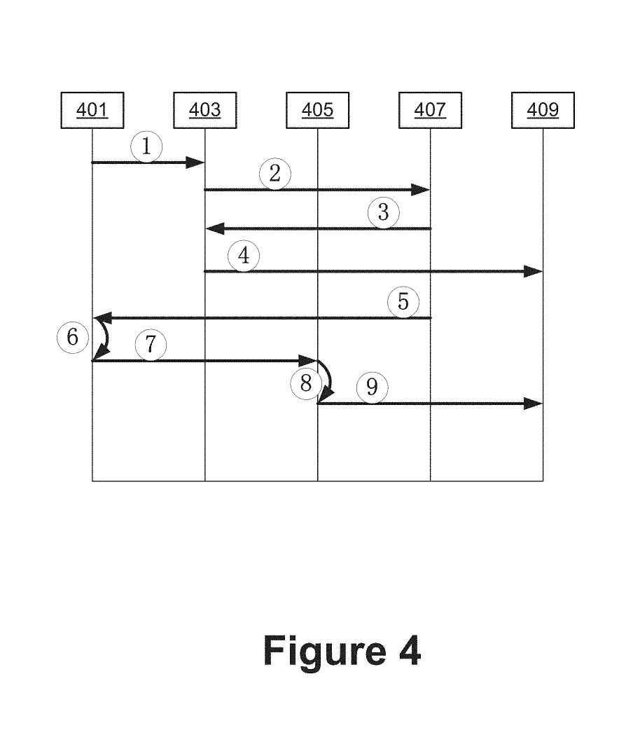

FIG. 4 is a data diagram of the image capture process wherein a portion of the image is enlarged by the user. The illustrated elements of the image data capture system in this view are the app or application 401, the in-memory preview surface 403, the in-memory enlarged view surface 405, the camera hardware 407, and the display 409 (102, 207).

At the start, the application 401 initializes the in-memory preview surface 403 (transition 1) which then starts the camera hardware 407 (transition 2). The camera hardware 407 then produces preview image data which is recorded in the in-memory preview surface 403 (transition 3), and the in-memory preview surface 403 is then drawn to the display 409 (transition 4).

The camera hardware 407 also provides the image data to the application 401 (transition 5) which then converts the data in transition 6 (e.g., from YUV to RGB) and forwards the data (transition 7) to the in-memory enlarged view surface 405. Based on the received data, a user-selected portion of the in-memory enlarged view surface 405 is enlarged (transition 8) before the in-memory enlarged view surface 405 is drawn to the display 409 (transition 9). At this point, the display 409 shows the original image but with the user-selected portion thereof enlarged. An example of the final image with the user-selected portion thereof enlarged is shown in FIG. 3 (image data 307).

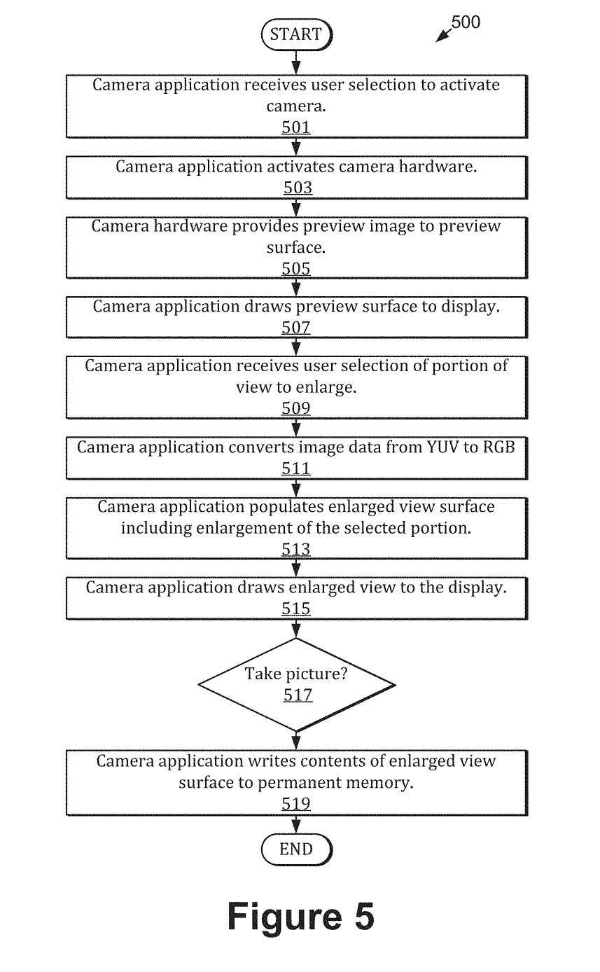

As noted above, the automated operations of the described image capture system are executed by the application 205, 401 based on user input actions. In an embodiment, the application 205, 401 executes actions by performing tasks in accordance with computer-executable instructions read from a non-transitory computer-readable medium. The tasks executed by the application 205, 401 in accordance with an embodiment of the described principles are shown in FIG. 5.

At stage 501 of the illustrated process 500, the application 205, 401 receives a user selection to activate device camera. The user selection may be made via a button press, selection of an icon on a touch screen or other suitable mechanism. The application 205, 401 initializes a preview surface at stage 503 (e.g., preview surface 403 of FIG. 4), and the application 205, 401 then activates the camera hardware at stage 503.

Under control of the application 205, 401, the camera hardware provides preview image data to the in-memory preview surface (e.g., in-memory preview surface 403) at stage 505. This preview surface is then drawn to the device display at stage 507 for the user to view. At this point, the display will show an image gathered by the camera, potentially updated as the camera moves, but with no enlargement of any portion. Under the direction of the application 205, 401, the displayed view may also include an indicator at a default location, allowing the user to select a portion of the view for enlargement. As noted above, the indicator may comprise a box, circle, dot or other visible emblem. A non-exhaustive example of such an indicator is embodied in element 302 of FIG. 3.

At stage 509, the application 205, 401 receives a user selection of a portion of the view to enlarge, e.g., via user manipulation of the indicator (see, e.g., indicator 302 of FIG. 3), and at stage 511, the application 205, 401 converts the image data gathered by the camera hardware, e.g., from YUV to RGB. The application 205, 401 then populates an enlarged view surface (e.g., in-memory enlarged view surface 405) with the converted data including an enlargement of the selected portion at stage 513, and draws the enlarged view to the display 409 (102, 207) in stage 515.

If the application 205, 401 then receives a user selection of a button, slider, switch, icon or other element to take a picture at stage 517, the application 205, 401 writes the contents of the enlarged view surface to permanent memory at stage 519. Otherwise, the application 205, 401 returns to stage 509 to continue to provide a preview image at the display responsive to camera movement and user manipulation of the enlargement indicator.

Although a cellular phone (including but not limited to a “smart” phone) has been used herein to exemplify the described principles, it will be appreciated that the device executing the system may be any device capable of image capture, e.g., a tablet, laptop computer, PC, workstation, surface device and so on.

Moreover, while the example provided above pertains to capture of a still image, it should be appreciated that the described principles also apply to other types of image capture, such as frames gathered via the automatic capture of a rapid series of images, and even individual frames in a video capture.

Although the described example employs both a preview surface and an enlarged view surface, it is not necessary to have separate in-memory surfaces. In an embodiment, the preview surface is overwritten with the enlarged view as an alternative to storing the enlarged view separately in an enlarged view surface.

It will be appreciated that a system and method for image data manipulation within a cellular phone or dedicated image capture device have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. An image capture device comprising:
camera hardware to generate image data, the camera hardware including at least one image capture element, at least one lens and at least one aperture;
a device display linked to the camera hardware to display the generated image data, creating a displayed image;
a camera memory medium configured to record data representing an image corresponding to the generated image data; and
a non-transitory device memory medium having stored therein instructions for instantiating a camera application, the camera application being configured to receive a user request to enlarge a selected portion of the displayed image, and in response to modify the recorded image data such that the image corresponding to the modified recorded image contains an enlarged view of the selected portion, and write the modified recorded image data to the device display.

2. The image capture device in accordance with claim 1, wherein the camera application is configured to write the modified recorded image data to the device memory in response to receiving an instruction to capture the image data.

3. The image capture device in accordance with claim 1, wherein the camera application is further configured to receive the user request to enlarge a selected portion of the image via user manipulation of an indicator shown on the device display.

4. The image capture device in accordance with claim 1, wherein image capture element is one of a CMOS (complementary metal-oxide semiconductor) device and a CCD (charge-coupled device).

5. The image capture device in accordance with claim 1, wherein the camera memory medium is separate from device memory medium.

6. The image capture device in accordance with claim 1, wherein the camera memory medium is a volatile memory medium.

7. The image capture device in accordance with claim 1, wherein the camera memory medium and the device memory medium are portions of a shared memory medium.

8. A portable cellular communication device comprising:
image capture hardware;
a display;
a first memory medium linked to the image capture hardware for storing a preview image gathered by the image capture hardware, and from which the display is written;
a second memory medium for storing a captured image based on the preview image; and
a camera application configured to receive user input from the display relative to the displayed preview image and, in response to said user input, to enlarge a user-selected portion of the preview image, producing a modified image.

9. The portable cellular communication device in accordance with claim 8, wherein camera application is configured to write data corresponding to the modified image to the second memory medium in response to receiving an instruction to capture image data.

10. The portable cellular communication device in accordance with claim 8, wherein the user input is received via user manipulation of an indicator shown on the display.

11. The portable cellular communication device in accordance with claim 8, wherein the first memory medium is separate from the second memory medium.

12. The portable cellular communication device in accordance with claim 8, wherein the first memory medium is a volatile memory medium.

13. The portable cellular communication device in accordance with claim 8, wherein the first memory medium and the second memory medium are portions of a shared memory medium.

14. A method of capturing image data comprising:
receiving preview image data;
displaying a preview image corresponding to the preview image data;
displaying a user-interactive indicator visually overlaid on the displayed preview image;
receiving a user request via movement of the user-interactive indicator to enlarge a portion of the preview image;
in response to receiving the user request, modifying the preview image data such that the corresponding modified preview image contains an enlarged portion in accordance with the user request; and
displaying the modified preview image.

15. The method in accordance with claim 14, wherein receiving preview image data comprises receiving image data from image capture hardware.

16. The method in accordance with claim 14, wherein the user-interactive indicator includes one or more of a circle and a rectangle.

17. The method in accordance with claim 14, further comprising storing the preview image data in a volatile memory medium, and storing the modified preview image data in the volatile memory medium.

18. The method in accordance with claim 14, further comprising receiving a user request to capture the modified preview image and, in response, writing the modified preview image data to a nonvolatile memory medium.

19. The method in accordance with claim 18, wherein writing the modified preview image data to a nonvolatile memory medium includes altering the modified preview image data to include a border surrounding the enlarged portion.

20. The method in accordance with claim 18, wherein the border surrounding the enlarged portion comprises a blurred line.
